(19) United States
(12) Patent Application Publication
(10) Pub. No.: US 2016/0302058 A1
(43) Pub. Date: Oct. 13, 2016

(54) METHODS AND NODES FOR UPDATING OF MAC ADDRESS

(71) Applicant: Telefonaktiebolaget L M Ericsson (publ), Stockholm (SE)

(72) Inventors: Filip Mestanov, Sollentuna (SE); Guido Hiertz, Aachen (DE); Leif Wilhelmsson, Dalby (SE)

(73) Assignee: Telefonaktiebolaget L M Ericsson (publ), Stockholm (SE)

(21) Appl. No.: 14/437,268

(22) PCT Filed: Mar. 26, 2015
(86) PCT No.: PCT/SE15/50364

§ 371 Date: Apr. 21, 2015

Related U.S. Application Data
(60) Provisional application No. 62/042,275, filed on Aug. 27, 2014.

(51) Int. Cl. H04W 8/26; H04L 29/12

(52) U.S. Cl. CPC H04W 8/26; H04L 61/2038; H04L 61/6022; H04W 84/12

(57) ABSTRACT

Methods and a first node for updating a MAC address of the first node and a second node for managing an update of a MAC address of a first node are disclosed. The first node sends, over the WLAN connection to the second node, a request for a second MAC address. The second node receives, over the WLAN connection from the first node, a request for a second MAC address.

### TECHNICAL FIELD

Embodiments herein relate to wireless networks, such as local wireless networks including a wireless access node and a wireless device. A method and a first node, such as the wireless device, for updating a MAC address of the first node as well as a method and a second node, such as the wireless access node, for managing an update of a MAC address of the first node are disclosed.

### BACKGROUND

In a wireless network, there is a need for identification of wireless device forming part of the wireless network. The identification may be used to provide a simple authentication to allow a wireless device to access the wireless network.

In Wireless Local Area Network (WLAN) technology, a Media Access Control (MAC) address of a STAtion (STA), such as a wireless device, is a unique identifier that is assigned to the wireless network interface. The MAC address has a length of 6 bytes, organized as shown in FIG. 1.

The STA's MAC address is exposed every time a STA decides to transmit a frame. In that sense, a WLAN network node can obtain the MAC address of the STA after the very first frame it receives from that STA.

Up until recently, the MAC address associated to a particular mobile device was kept unchanged throughout the lifetime of the device (sort of a permanent device identity). However, recent events have shown that in some situations, using the same MAC address could compromise privacy and allow for user location tracking. Thus, in order to solve a problem related to privacy, some mobile device vendors have come up with mechanisms that allow the mobile device to randomize its MAC address every time it has to open a new connection and by doing so preventing user location tracking.

However, there exist many situations when a WLAN Access Point (AP) would benefit from the STAtion (STA), e.g. a wireless device, using the same MAC address every time it connects to a certain AP. For example, in many cases an AP would store information on previously connected STAs in order to improve the user experience during consecutive connections. The information type that the AP can store depends on the scenario, but it could include user preferences, STA specific settings at the AP, etc. Furthermore, in scenarios where the WLAN system is integrated with a cellular system, the STA MAC address is usually used to link the WLAN information with the respective cellular information. The entire collection of information and preferences that pertains to a particular STA (and a user) is referred to as context.

In some situations, the STA will need to use its permanent MAC address in order to enable smart network functionality, while in others it will need to change its MAC address to prevent user location tracking. The smart network functionality may be that the WLAN AP stores information relating to the previously connected STA as mentioned above, e.g. a so called context of the STA is stored for use at a later stage.

### SUMMARY

An object may be to increase privacy, e.g. prevent user location tracking, while at the same time maintain user experience, e.g. thanks to smart network functionality.

According to a first aspect, the object is achieved by a method, performed by a first node, such as a STA or WLAN AP, for updating a MAC address of the first node. A WLAN connection is established between the first node and a second node. The first node is identified by a first MAC address. The first node sends, over the WLAN connection to the second node, a request for a second MAC address.

According to a second aspect, the object is achieved by a first node for updating a MAC address of the first node. A WLAN connection is established between the first node and a second node. The first node is identified by a first MAC address. The first node is configured for sending, over the WLAN connection to the second node, a request for a second MAC address.

According to a third aspect, the object is achieved by a method, performed by a second node, such as a STA or WLAN AP, for managing an update of a MAC address of a first node. A WLAN connection is established between the first node and the second node. The first node is identified by a first MAC address. The second node receives, over the WLAN connection from the first node, a request for a second MAC address.

According to a fourth aspect, the object is achieved by a second node for managing an update of a MAC address of a first node. A WLAN connection is established between the first node and the second node. The first node is identified by a first MAC address. The second node is configured for receiving, over the WLAN connection from the first node, a request for a second MAC address.

Moreover, according to further aspects, the object above is achieved by computer programs and carriers for computer programs, which correspond to the aspects above.

Thanks to that the first node sends a request for a second MAC address to the second node, the first node may alter its identity, i.e. change from being identified by the first MAC address to be identified by the second MAC address. In this manner, the first and second nodes achieve a common understanding of which MAC address, i.e. the second MAC address, the first node will be identified by at a later stage. Thereby, e.g. context and/or a so called network profile may be restored for the first node. As a result, the above mentioned object may be achieved.

Advantageously, privacy of a user, e.g. a user of the first node, is improved or increased, e.g. user tracking is made more difficult—at least.

### BRIEF DESCRIPTION OF THE DRAWINGS

The various aspects of embodiments disclosed herein, including particular features and advantages thereof, will be readily understood from the following detailed description and the accompanying drawings, in which:

FIG. 1 is overview of field structure of a MAC address,

FIG. 2 is a schematic overview of an exemplifying wireless network in which embodiments herein may be implemented,

FIG. 3 is a combined signalling and flowchart illustrating the methods herein,

FIG. 4 is another combined signalling and flowchart illustrating the methods herein,

FIG. 5 is a further combined signalling and flowchart illustrating the methods herein,

FIG. 6 is yet another combined signalling and flowchart illustrating the methods herein,

FIG. 7 is a flowchart illustrating embodiments of the method in the first node,

FIG. 8 is a block diagram illustrating embodiments of the first node, FIG. 9 is a flowchart illustrating embodiments of the method in the second node, and

FIG. 10 is a block diagram illustrating embodiments of the second node.

### DETAILED DESCRIPTION

Throughout the following description similar reference numerals have been used to denote similar features, such as actions, steps, nodes, elements, units, modules, circuits, parts, items or the like, when applicable. In the Figures, features that appear in some embodiments are indicated by dashed lines.

With increasing adoption of Wi-Fi devices privacy concerns associated with the technology have become more and more apparent. Wi-Fi devices tend to use the same identifier, i.e. a MAC address, when connecting to different networks and this identifier does not change over time. However, some Wi-Fi device vendors have lately adopted measures in order to improve user privacy by periodically changing the MAC address of the device. One such example is Apple's iOS 8 feature for MAC address randomization every time a new connection is initiated.

While this feature does provide an increased privacy in some cases, it could lead to degradation in user experience in others. Some networks require the device to use the same identifier every time it connects in order to fetch previously stored information associated with that device, i.e. the device's or user's context.

There is currently no mechanism that would allow the STA, such as a wireless device, to use a MAC address that the wireless access point recognizes and can relate to the STA's stored context, while at the same time alleviating privacy issues. Furthermore, once the STA connects to a certain WLAN AP, which could be one AP, but in the majority of the cases it is a plurality of Aps, it keeps reusing the same MAC address when roaming within the network.

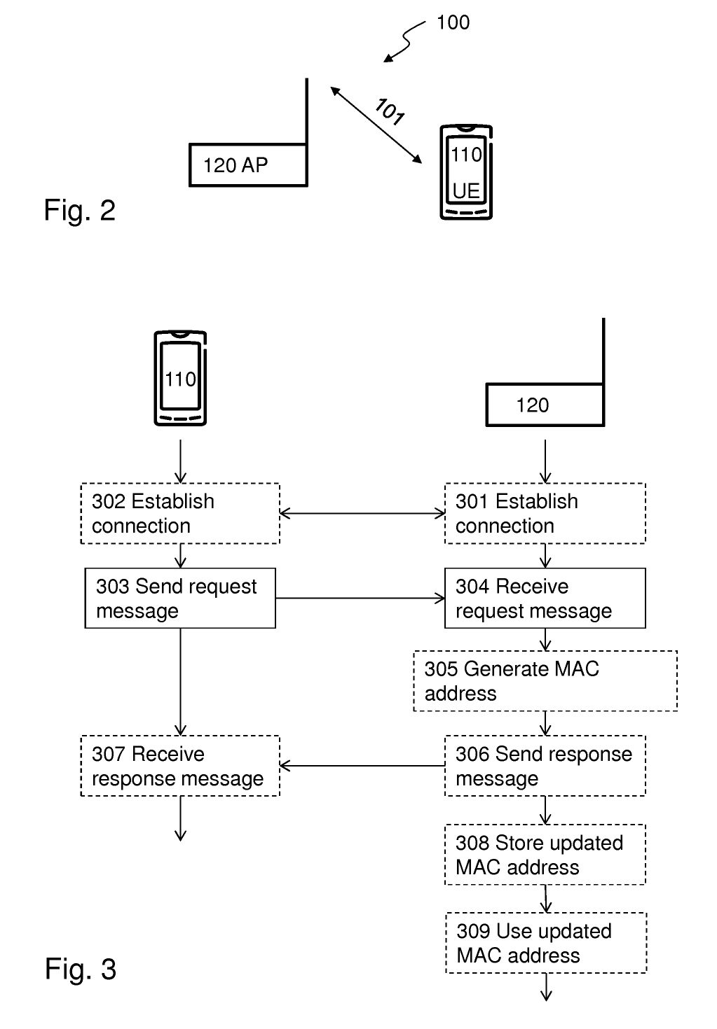

FIG. 2 depicts an exemplifying wireless network 100 in which embodiments herein may be implemented.

The wireless network 100 may be any network from the Institute of Electrical and Electronics Engineers (IEEE) 802.11 standards suite, often referred to as Wi-Fi networks. In other examples, the wireless network 100 may be a Bluetooth network, Bluetooth Low Energy network or the like.

In this example, the wireless network 100 comprises a wireless device 110 and a wireless access node 120, such as a WLAN Access Points (WLAN AP). A WLAN access point may be identified by a WLAN Access Point Name (APN), Extended Service Set Identification (ESSID), Homogenous Extended Service Set Identification (HESSID or the like. The wireless device 110 may be located in the vicinity of the wireless access node 120.

As used herein, the term “wireless device” may refer to a user equipment, a mobile phone, a cellular phone, a Personal Digital Assistant (PDA) equipped with radio communication capabilities, a smartphone, a laptop or personal computer (PC) equipped with an internal or external mobile broadband modem, a tablet PC with radio communication capabilities, a portable electronic radio communication device, a sensor device equipped with radio communication capabilities or the like. The sensor may be any kind of weather sensor, such as wind, temperature, air pressure, humidity etc. As further examples, the sensor may be a light sensor, an electronic switch, a microphone, a loudspeaker, a camera sensor etc. It may here also be noted that the term “user” may refer to the wireless device.

FIG. 3 illustrates one exemplifying method when implemented in the wireless network 100 of FIG. 2. In this example, the first node, initially mentioned in the summary section, is exemplified by the wireless device 110 and the second node, also initially mentioned in the summary section, is exemplified by the wireless access node 120.

Thus, the wireless device 110 may perform a method for updating a MAC address, e.g. changing from a first MAC address to a second MAC address. In some examples, the wireless device 110 performs a method for altering its MAC address, i.e. altering the MAC address e.g. by changing a value thereof. The wireless access node 120 may perform a method for managing an update of a MAC address of a wireless device 110. Again, the update of the MAC address may be that a first MAC address is replaced by a second MAC address.

The following actions may be performed in any suitable order.

Actions 301 and 302 are performed in order to set up a connection between the wireless device 110 and the wireless access point 120.

Action 301

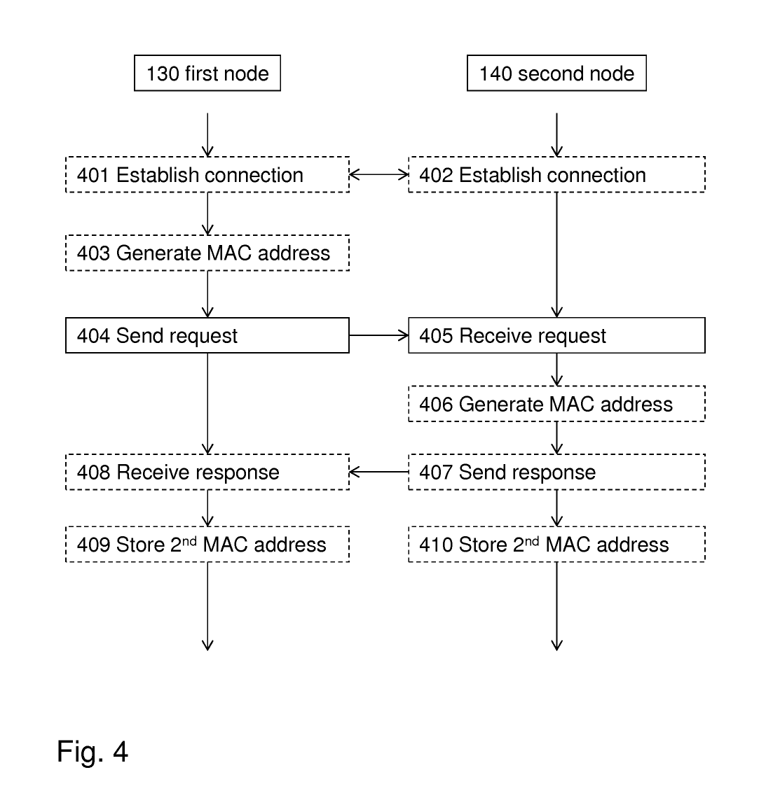

The wireless access node 120 may establish a connection towards the wireless device 110. This action may include one or more of the actions A, B and C of FIG. 4 and/or 5.

Action 302

The wireless device 110 may establish a connection towards the wireless access node 120. This action may include one or more of the actions A, B and C of FIG. 4 and/or 5.

At this stage, the wireless device 110 may be identified by the wireless access node 120 by means of a first MAC address, e.g. stored in a memory of the wireless device 110.

Action 303

The wireless device 110 sends a request message to the wireless access node 120. In this manner, the request message may initiate an update of the MAC address of the wireless device 110.

In a first example, the request message indicates which MAC address the wireless device 110 may use at a later stage.

In a second example, the request message instructs the wireless access node 120 to send a MAC address to the wireless device 110, which MAC address is to be used at a later stage.

In a third example, the request message instructs the wireless access node 120 that the MAC address currently being used will be the MAC address to be used at a later stage. This may mean that the request message includes an indication, or flag, that the current MAC address will be used also at a later stage.

This means that the request message may initiate an exchange of the first MAC address. Accordingly, the first MAC address may be replaced by a second MAC address, which may be indicated by the request message or provided by the wireless access node 120 in a response message as in action 306 below.

Action 304

Subsequent to action 303, the wireless access node 120 receives the request message.

Action 305

Following the second example in action 303, the wireless access node 120 may generate a MAC address, e.g. the second MAC address, to be used by the wireless device 110, e.g. at a later stage.

In some cases, this action may be performed autonomously by the wireless access node 120, i.e. when the MAC update procedure is initiated by the wireless access node 120 itself.

Action 306

Again following the second example, the wireless access node 120 may send a response message to the wireless device 110.

The response message may thus indicate an updated MAC address, e.g. a second MAC address, to be used by the wireless device 110 at a later stage. In some examples, the response message includes the updated MAC address. In other examples, the updated MAC address may be derived from the response message. As an example, the derivation of the updated MAC address may be that the response message includes a value to be added to the existing, i.e. the first, MAC address.

In some cases, this action may be performed autonomously by the wireless access node 120, i.e. when the MAC update procedure is initiated by the wireless access node 120 itself.

In some examples, the response message may include an acknowledgement of the second MAC address, or an acknowledgement of that the wireless access node 120 has received and acts in line with the request message.

Action 307

The wireless device 110 may receive the response message sent by the wireless access node 120 in action 306.

Action 308

The wireless access node 120 may store the updated MAC address in a memory of the wireless access node 120, or in a database accessible by the wireless access node 120. In this manner, the updated MAC address may be used at a later stage, e.g. in action 309 below.

Action 309

The wireless access node 120 may use updated MAC address during establishment of another connection between the wireless device 110 and the wireless access node 120. By use of the updated MAC address, the wireless access node 120 may be able to identify the wireless device 110 even though the wireless device uses the updated MAC address. Accordingly, e.g. context of the wireless device, e.g. user, may be loaded, or restored. In this manner, user experience may be maintained while at the same time privacy and/or security relating to the user of the wireless device 110 is increased, e.g. thanks to use of dynamic change of MAC address in the wireless device 110.

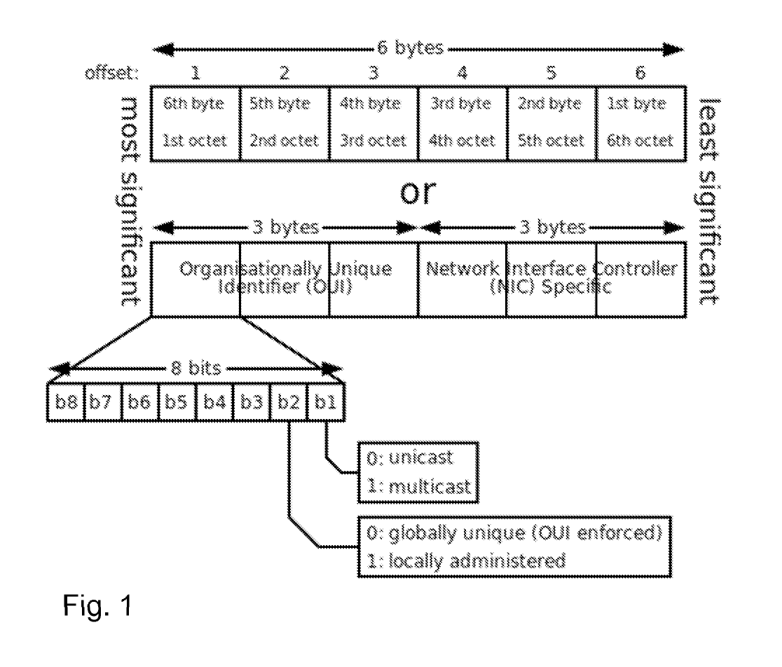

FIG. 4 illustrates further exemplifying methods when implemented in the wireless network 100 of FIG. 1. This example is more general than the example of FIG. 3. In some cases, a first node 130 may be the wireless device 110 when a second node 140 may be the wireless access node 120, i.e. when the wireless device 110 initiates the MAC address procedure, or MAC update procedure. In other cases, the first node 130 may be the wireless access node 120 when the second node 140 may be the wireless device 110, i.e. when the wireless access node 120 initiates the MAC address procedure. The wireless network 100 may thus comprise the first and second nodes 130, 140.

This means that the first node 130 performs a method for updating a MAC address of the first node 130 and the second node 140 performs a method for managing an update of a MAC address of the first node 130.

As mentioned above in action 301 and 302 as well as below in action 401 and 402 a WLAN connection is established between the first node 130 and a second node 140. The first node 130 is identified by a first MAC address.

The following actions may be performed in any suitable order.

Action 401 and 402

A connection is established between the first and second nodes 130, 140. These actions are similar to actions 301 and 302.

Action 403

The first node 130 may generate the new MAC address, e.g. the second MAC address. This action is thus performed by the first node 130. The action 403 is similar to action 406, but performed by the first node 130.

Action 403 may thus be performed before action 404, e.g. when the request message comprises the new MAC address, which may be generated in this action.

Action 404

The first node 130 sends, to the second node 140, a request, or a request message for the second MAC address. The request may preferably be encrypted. The request is typically sent over the WLAN connection.

The request may include an indication that a new MAC address, e.g. the second MAC address, is requested, i.e. the first node 130 wishes to receive the new MAC address from the second node.

In other examples, the request may include the new MAC address to be used by the first node 130 when connecting to the second node 140 at a later stage. In these examples, action 403 above is typically performed.

As mentioned above, the request may in some examples indicate to the wireless access node that the current MAC address will be used when re-connecting, e.g. establishing a connection to the wireless access node after being disconnected therefrom, at a later stage.

The request may be included in a further Information element carried in an Action frame as elaborated in section “Frame format and frame type” below. In particular, the further Information element may be a further vendor specific element.

This action relates to both STA initiated and WLAN initiated MAC update procedure. STA initiated MAC update procedure refers to that the wireless device 110 of FIG. 3 triggers the MAC update procedure. Similarly, WLAN initiated MAC update procedure refers to that the wireless access node 120 of FIG. 3 triggers the MAC update procedure.

Action 405

Subsequent to action 404, the second node 140 receives the request sent by the first node 130 in action 404.

Action 406

The second node 140 may generate the new MAC address, e.g. the second MAC address. Typically, action 403 is not performed when action 406 is performed.

In some cases, this action is performed in response to the reception of the request, i.e. when the MAC update procedure is initiated by the first node 130.

In some other cases, action 403 is performed by the first node 130. Then, action 406 may not necessarily be performed.

Action 407

The second node 140 may send a response, or response message, to the first node 130. The response indicates acknowledgement or non-acknowledgement of the request. In this manner, the second node 140 provides a confirmation that the request has been received and the second node 140 acts accordingly. The response may preferably be encrypted.

The response may also or alternatively include:

a second MAC address to be used by the first node 130;

an instruction to the first node 130 that the request is denied, e.g. a non-acknowledgment message;

an instruction to the first node 130 that a proposed MAC address, i.e. the second MAC address, cannot be used. This may for example happen if another wireless device already has occupied that MAC address to identify stored information relating to a context thereof;

a confirmation that the request has been received and the second node acts accordingly, e.g. an acknowledgement message (as mentioned above); and the like.

Action 408

The first node 130 may receive, from the second node 140, the response for indicating acknowledgement or non-acknowledgement of the request. The response may be included in an Information element carried in an Action frame as explained in section “Frame format and frame type” below. In particular, the Information element may be a vendor specific element.

Action 409

Thus, the first node 130 may store the second MAC address. The first node 130 may further store information relating to time of validity for the second MAC address.

In some examples, when the first node 130 is a wireless device 110, the second MAC address and the information relating to time of validity for the second MAC address may be included in a network profile. See also section “Frame format and frame type”.

In some other examples, when the first node 130 is be a wireless access node 120, the second MAC address and the information relating to time of validity for the second MAC address may be included in a Station context. See also section “Frame format and frame type”.

Action 410

Similarly, the second node 140 may store the second MAC address. The second node 140 may further store information relating to time of validity for the second MAC address.

Action 309 of FIG. 3 above may also be performed by the first node 130 and/or the second node 140 in various embodiments.

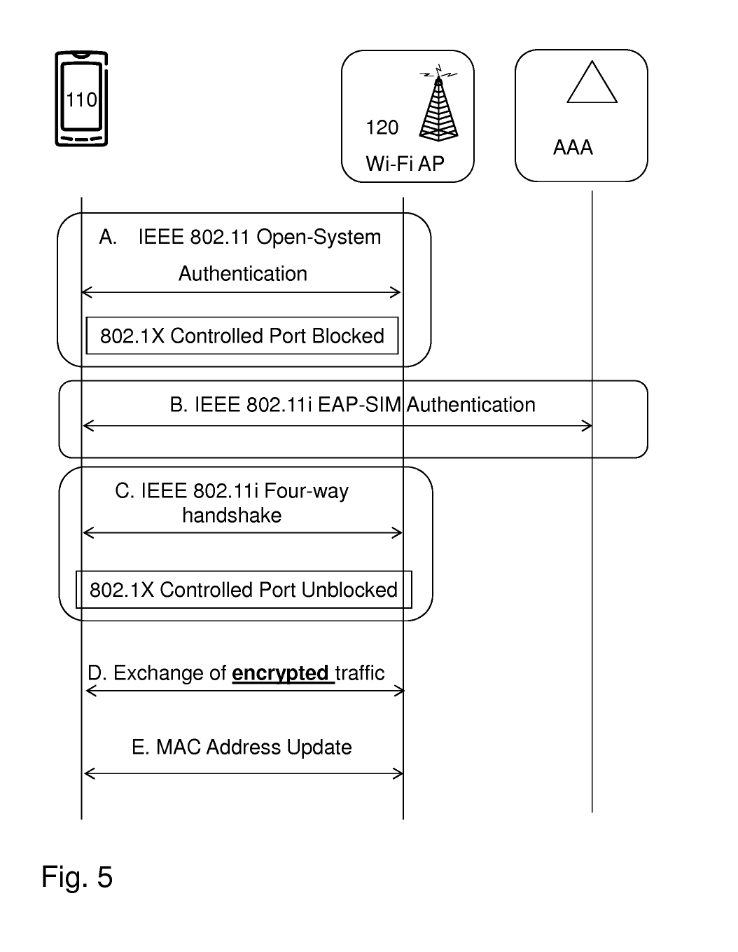

Now turning to FIG. 5, there is shown according to one embodiment, a STA 110 and a WLAN AP 120 that agree on a MAC address to be used by the STA 110 for communicating to that same AP or other APs that belong to the same network at a later point, or stage, in time. This procedure involves both the STA and the AP, but can be initiated by either party according to related embodiments. In order for intruders to not be able to “sniff”, e.g. capture and read, the new MAC address, the MAC address communication between the AP and the STA is carried by means of encrypted messages. This imposes the requirement that the STA has to successfully authenticate to an AP before a MAC update procedure, e.g. including one or more of actions 303, 304, 305, 306 and 307, may take place. For the sake of simplicity, but purely as one example out of many possible examples, FIG. 5 shows exemplifying actions by which the MAC address update can be implemented. In this example, the first node 130 is exemplified by the STA 110 and the second node 140 is exemplified by the WLAN AP 120.

The following actions may be performed:
A. IEEE Open System Authentication (OSA) procedure: The STA 110 carries a simple authentication and association to the AP 120. The STA 110 cannot route any but authentication frames at this point and no over-the-air encryption is used.
B. Extensible Authentication Protocol-Subscriber Identity Module (EAP-SIM): The STA 110 authenticates with the network and vice versa (here an EAP-SIM procedure is shown; any other authentication procedure can be carried out). Encryption keys are distributed from the AAA (Authenticating Server, AS) to the WLAN AP 120 after a successful authentication.
C. Four-way handshake: The over-the-air encryption is setup for both the unicast and multicast traffic between the AP 120 and the STA 110. After the successful completion of the four-way handshake the STA 110 can route any type of traffic and this traffic is encrypted.
D. Exchange of encrypted traffic is enabled: Any type of traffic may thus be routed between the STA 110 and the WLAN AP 120. The traffic is encrypted.
E. MAC update procedure: At this point, the STA 110 and the WLAN AP 120 can carry the MAC update procedure, using over-the-air encryption in order to ensure the data integrity.

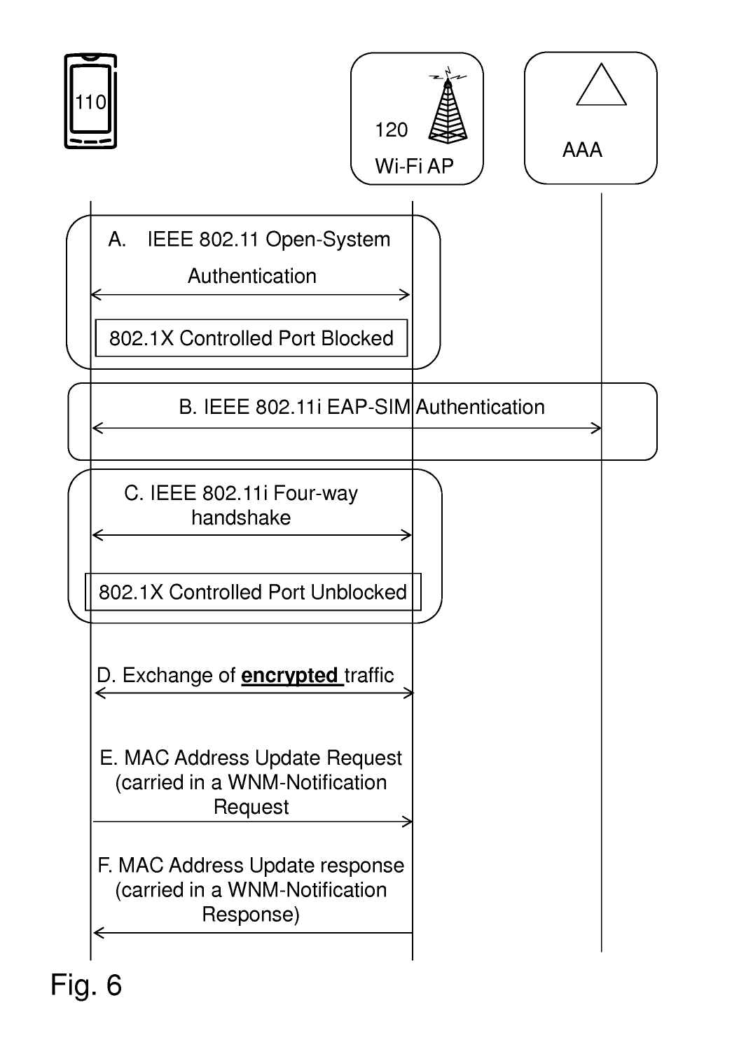

In another embodiment with reference to FIG. 6, related to the previous embodiment, the STA 110 initiates the MAC update procedure. There is a plurality of STA initiated embodiments. These embodiments differentiate from the embodiment of FIG. 5 in actions E and F of FIG. 6. In action E, the STA 110 sends a request for a second MAC address in an WNM-notification request. In action F, the STA 110 receives, from the WLAN AP 120, a MAC address update response carried in a WNM-notification response.

In one embodiment, the STA 110 notifies the AP 120 that the MAC address will be updated, also providing the MAC address that the STA 110 will be using.

In a second embodiment, the STA 110 requests that the AP 120 allocates a MAC address and that the AP 120 communicates it to the STA 110. The update can potentially be acknowledged by the receiving side, i.e. the STA 110.

In a third embodiment, the STA 110 notifies the AP 120 that the MAC address it is currently using will be used in the future when the STA 110 connects to the AP 120.

In an example when the MAC update procedure is STA initiated: A new MAC address, e.g. the second MAC address, suggested by the STA 110 may be acknowledged, e.g. using the response message, by the AP 120 in some cases.

In another embodiment, the AP 120 initiates the MAC update procedure. The AP 120 may request that the STA 110 changes its MAC address. Following such request the STA 110 may either accept or reject the request; if it accepts a MAC update procedure is carried out.

In another example when the MAC update procedure is AP initiated, the AP 120 may allocate a MAC address to the STA 110, e.g. the AP 120 determines the second MAC address. The STA 110 may either accept or reject the proposed (second) MAC address, which may be received by the STA 110 in the response message.

In another embodiment, the content of the MAC address update message, e.g. the request message above, is defined. There are several things that could be included in the message:
The MAC address to be used by the STA 110, i.e. the second MAC address,
When the new (second) MAC address will be used by the STA, e.g., after a certain period, during a consecutive connection, during an AP transition, etc,
Validity period of the new MAC address, e.g., could be a time period: an hour, a day, a month; could be valid only for the current association, etc,
Application scope, e.g. if the new MAC should be used only with the current AP, i.e., the current BSSID the STA is connected to, a plurality of APs, i.e., within an ESS, etc., a plurality of networks, e.g., the Network Access Identifier realm, NAI realm, etc.

### Frame Format and Frame Type

Another embodiment relates to the mechanism used to implement the MAC update procedure. There are several options here. One option is to carry the MAC update messages in a new IEEE 802.11 frame (hereafter referred to as MAC Update frame). Currently, there are three fundamental types of frames defined in the IEEE 802.11 standard (see table 8-1 of IEEE 802.11-2012):
Management frames (Probe, Association, Authentication, etc.)
Control frames (RTS, CTS, ACK, etc.)
Data frames (Data, QoS Data, etc.)

One option to implement this with compliance to the current IEEE normative is to define a new fundamental frame type (in addition to three described above). Currently, the Type Value of “11” (binary notation) is reserved for future use and its adoption to implement the MAC Update frame is one possibility. Another option is to use on of the existing frame types and amend it with a new subtype. An example of such an implementation is taking the Management frame type (“00”) and defining a new subtype within the Management type. Currently values “0111” and “1111” are reserved for future use and could be one of the options for implementing the MAC Update frame. Since there is a requirement on the usage of data integrity for the MAC update procedure, the MAC Update frame has to be implemented as a Robust frame (Protected Management Frames, PMF mechanism needs to be considered). Yet another option is to implement the MAC Update frame as a vendor specific element (to be carried in an already existing frame, e.g., Vendor-specific Action frame, WNM-Notification frame, (Re-) Association frame, etc.). This means for example that the Information element may be a vendor specific element and/or the further Information element may be a further vendor specific element. One exemplary message flow is shown on FIG. 5. Please note that this is one exemplifying way of implementing the MAC update procedure.

In one embodiment, a mechanism is proposed by which the STA retains the information about the updated MAC address. Currently, STAs keep network profiles for each AP (or plurality of APs) the STA has been previously connected to. This profile contains various types of information related to network identity, authentication mechanisms, last observed channel, etc. In this embodiment, we propose that the STA adds the updated MAC address (along with its attributed, e.g., the validity conditions, application scope, etc.) to the network profile for the saved network.

In another embodiment, related to the previous embodiment, the AP stores information regarding the updated MAC address to be used by the STA. Currently, AP might retain some information about STAs that have been previously associated to that AP. This information is usually called the STA context and relates to authentication information, user preferences, etc. In this embodiment we propose that the updated MAC address (and its attributes) is added to the STA context.

In view of the embodiments above, there is provided a method by which the WLAN network, e.g. a WLAN AP, and the STA may negotiate, e.g. via encrypted signalling, a MAC address that the STA may use at a later stage when communicating to this WLAN network, e.g. a particular AP or any other AP belonging to the same WLAN network.

Hence, a WLAN STA may be able to change its MAC address to e.g. a seemingly random one in order to improve user privacy, while at the same time the WLAN itself can keep providing user context enabled functionality. The WLAN is aware that the updated MAC address belongs to the same STA so that it can relate the new MAC address to the old one and use the stored user context.

With the methods according to embodiments herein, a STA may change its MAC address, e.g. from the first MAC address to the second MAC address. The change of MAC address may be before starting/establishing a connection or during an active connection. In this manner, the user's privacy is improved or increased, e.g. user tracking is made more difficult—at least. However, the network functionality that depends on the AP being able to reuse the STA's context can still be used, since the AP is aware of the MAC address that the STA will change to, e.g. a second MAC address.

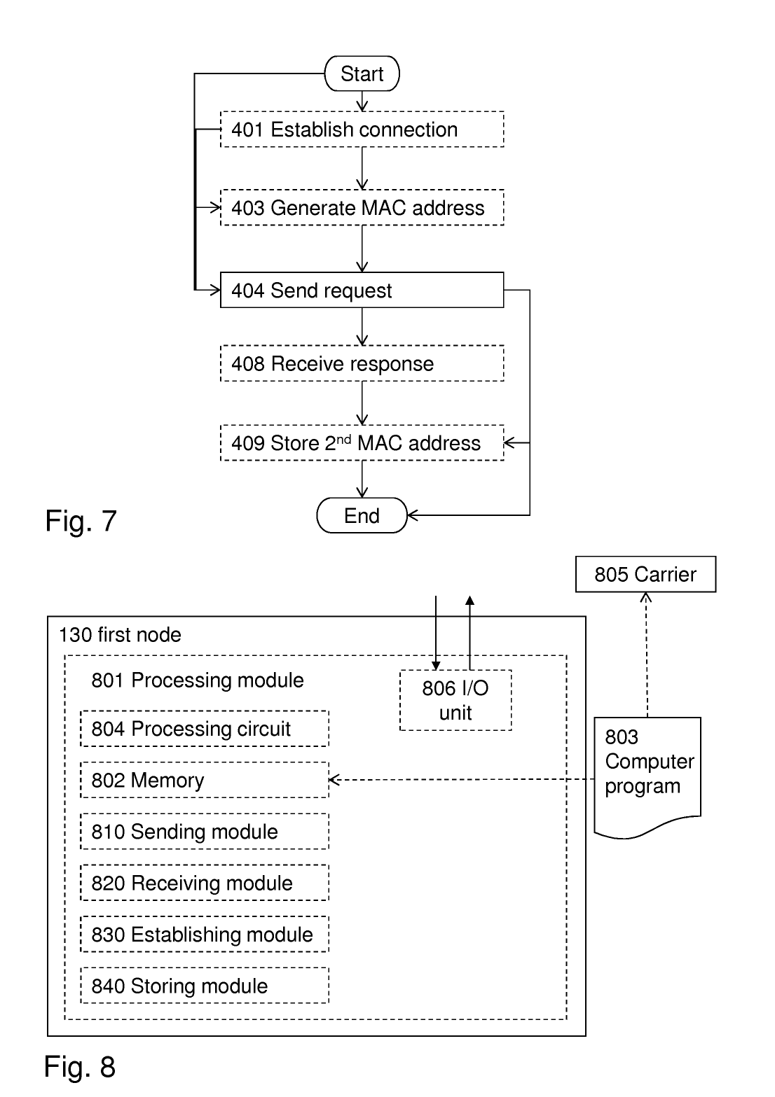

In FIG. 7, an exemplifying, schematic flowchart of the method in the first node 130, such as the wireless device 110, is shown. The same reference numerals as used in connection with FIG. 4 have been applied to denote the same or similar actions. Accordingly, the first node 130 performs a method for updating a MAC address of the first node 130, wherein a Wireless Local Area Network “WLAN” connection is established between the first node 130 and a second node 140, wherein the first node 130 is identified by a first Media Access Control “MAC” address.

The following action may be performed in any suitable order.

Action 401

A connection is established between the first and second nodes 130, 140.

Action 403

The first node 130 may generate the new MAC address, e.g. the second MAC address.

Action 404

The first node 130 sends, over the WLAN connection to the second node 140, a request for a second MAC address.

The request may include an indication that the second MAC address is requested.

The request may include the second MAC address to be used by the first node 130 when connecting to the second node 140 at a later stage.

The request may be included in a further Information element carried in an Action frame. The further Information element may be a further vendor specific element.

Action 408

The first node 130 may receive, from the second node 140, a response for indicating acknowledgement or non-acknowledgement of the request.

The response may be included in an Information element carried in an Action frame. The Information element may be a vendor specific element.

Action 409

The first node 130 may store 409 the second MAC address.

The storing 409 may comprise storing information relating to time of validity for the second MAC address.

The first node 130 may be a wireless device 110 and wherein the second MAC address and the information relating to time of validity for the second MAC address may be included in a network profile.

The first node 130 may be a wireless access node 120 and wherein the second MAC address and the information relating to time of validity for the second MAC address may be included in a Station context.

The first node 130 may be a wireless device 110 and the second node 140 may be a wireless access node 120, or wherein the first node 130 may be a wireless access node 120 and the second node 130 may be a wireless device 110.

With reference to FIG. 8, a schematic block diagram of the first node 130, e.g. the wireless device 110, is shown.

The first node 130 may comprise a processing module 801, such as a means, one or more hardware modules and/or one or more software modules for performing the methods described herein.

The first node 130 may further comprise a memory 802. The memory may comprise, such as contain or store, a computer program 803.

According to some embodiments herein, the processing module 801 comprises, e.g. ‘is embodied in the form of’ or ‘realized by’, a processing circuit 804 as an exemplifying hardware module. In these embodiments, the memory 802 may comprise the computer program 803, comprising computer readable code units executable by the processing circuit 804, whereby the first node 130 is operative to perform the methods of FIG. 3, 4, 5, 6 and/or 7.

In some other embodiments, the computer readable code units may cause the first node 130 to perform the method according to FIG. 3, 4, 5, 6 and/or 7 when the computer readable code units are executed by the first node 130.

FIG. 8 further illustrates a carrier 805, comprising the computer program 803 as described directly above. The carrier 805 may be one of an electronic signal, an optical signal, a radio signal, and a computer readable medium.

In some embodiments, the processing module 801 comprises an Input/Output (I/O) unit 806, which may be exemplified by a receiving module and/or a sending module as described below when applicable.

In further embodiments, the first node 130 and/or the processing module 801 may comprise one or more of a sending module 810, a receiving module 820, an establishing module 830 and a storing module 840 as exemplifying hardware modules. In other examples, the aforementioned exemplifying hardware module may be implemented as one or more software modules. These modules are configured to perform a respective action as illustrated in e.g. FIG. 7.

Therefore, according to the various embodiments described above, the first node 130 is, e.g. by means of the processing module 801 and/or any of the above mentioned modules, operative to, e.g. is configured to, perform the method of FIG. 7.

Hence, the first node 130 is configured for updating a MAC address of the first node 130, wherein a Wireless Local Area Network “WLAN” connection is established between the first node 130 and a second node 140, wherein the first node 130 is identified by a first Media Access Control “MAC” address.

The first node 130, the processing module 801 and/or the sending module 810 is configured for sending, over the WLAN connection to the second node 140, a request for a second MAC address.

As mentioned, the request may include an indication that the second MAC address is requested. The request may include the second MAC address to be used by the first node 130 when connecting to the second node 140 at a later stage. The request may be included in a further Information element carried in an Action frame. The further Information element may be a further vendor specific element.

The first node 130, the processing module 801 and/or the receiving module 820 may be configured for receiving, from the second node 140, a response for indicating acknowledgement or non-acknowledgement of the request.

The response may be included in an Information element carried in an Action frame. The Information element may be a vendor specific element.

The first node 130, the processing module 801 and/or the storing module 840 may be configured for storing the second MAC address.

The first node 130, the processing module 801 and/or the storing module 840 may be configured for storing the second MAC address by further storing information relating to time of validity for the second MAC address.

As mentioned, the first node 130 may be a wireless device 110 and wherein the second MAC address and the information relating to time of validity for the second MAC address may be included in a network profile.

The first node 130 may be a wireless access node 120 and wherein the second MAC address and the information relating to time of validity for the second MAC address may be included in a Station context.

The first node 130 may be a wireless device 110 and the second node 140 may be a wireless access node 120, or wherein the first node 130 may be a wireless access node 120 and the second node 130 may be a wireless device 110.

In FIG. 9, an exemplifying, schematic flowchart of the method in the second node 140, e.g. the wireless access node 120, is shown. The same reference numerals as used in connection with FIG. 4 have been applied to denote the same or similar actions. The second node 140 performs a method for managing an update of a MAC address of the first node 130, wherein a Wireless Local Area Network “WLAN” connection is established between the first node 130 and the second node 140, wherein the first node 130 is identified by a first Media Access Control “MAC” address.

As mentioned, the first node 130 may be a wireless device 110 and the second node 140 may be a wireless access node 120, or wherein the first node 130 may be a wireless access node 120 and the second node 130 may be a wireless device 110.

The following action may be performed in any suitable order.

Action 402

A connection is established between the first and second nodes 130, 140.

Action 405

The second node 140 receives, over the WLAN connection from the first node 130, a request for a second MAC address.

As mentioned, the request may include an indication that the second MAC address is requested. The request may include the second MAC address to be used by the first node 130 when connecting to the second node 140 at a later stage. The request may be included in a further Information element carried in an Action frame. The further Information element may be a further vendor specific element.

Action 406

The second node 140 may generate the new MAC address, e.g. the second MAC address.

Action 407

The second node 140 may send a response for indicating acknowledgement or non-acknowledgement of the request. Again, the response may be included in an Information element carried in an Action frame. The Information element may be a vendor specific element.

Action 410

The second node 140 may store the second MAC address. The storing may comprise storing information relating to time of validity for the second MAC address.

The first node 130 may be a wireless device 110 and wherein the second MAC address and the information relating to time of validity for the second MAC address may be included in a network profile.

The first node 130 may be a wireless access node 120 and wherein the second MAC address and the information relating to time of validity for the second MAC address may be included in a Station context.

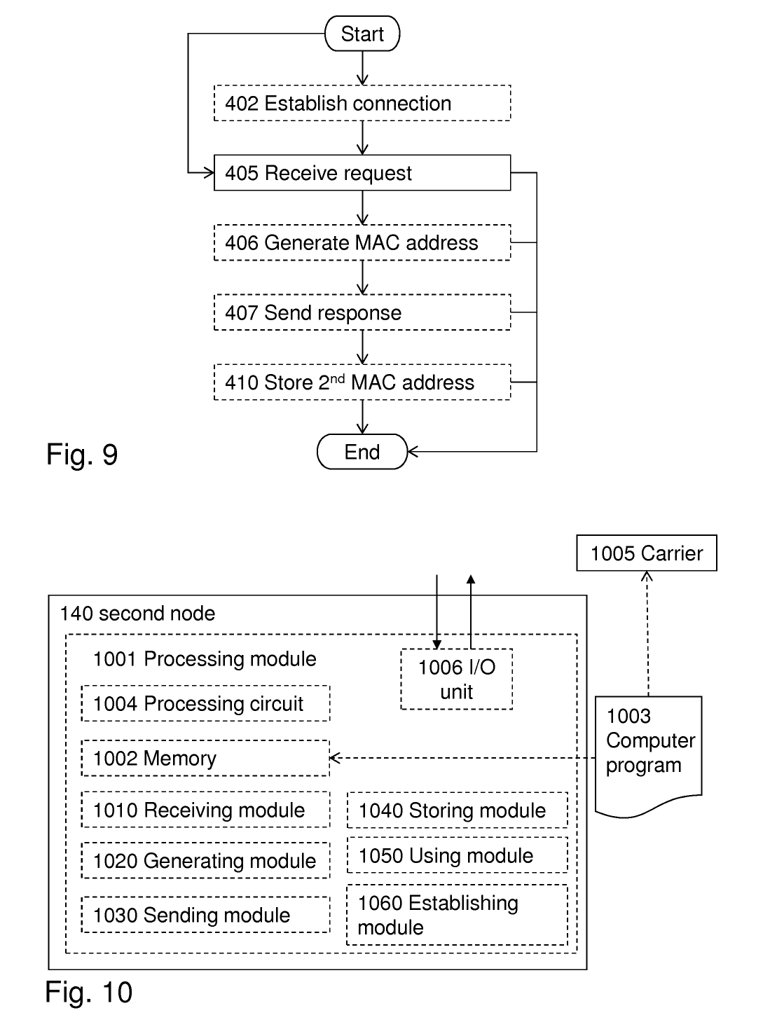

With reference to FIG. 10, a schematic block diagram of the second node 140, e.g. the wireless access node 120, is shown.

The second node 140 may comprise a processing module 1001, such as a means, one or more hardware modules and/or one or more software modules for performing the methods described herein.

The second node 140 may further comprise a memory 1002. The memory may comprise, such as contain or store, a computer program 1003.

According to some embodiments herein, the processing module 1001 comprises, e.g. ‘is embodied in the form of’ or ‘realized by’, a processing circuit 1004 as an exemplifying hardware module. In these embodiments, the memory 1002 may comprise the computer program 1003, comprising computer readable code units executable by the processing circuit 1004, whereby the second node 140 is operative to perform the methods of FIG. 3, 4, 5, 6 and/or 9.

In some other embodiments, the computer readable code units may cause the second node 140 to perform the method according to FIG. 3, 4, 5, 6 and/or 9 when the computer readable code units are executed by the second node 140.

FIG. 10 further illustrates a carrier 1005, comprising the computer program 1003 as described directly above. The carrier 1005 may be one of an electronic signal, an optical signal, a radio signal, and a computer readable medium.

In some embodiments, the processing module 1001 comprises an Input/Output (I/O) unit 1006, which may be exemplified by a receiving module and/or a sending module as described below when applicable.

In further embodiments, the second node 140 and/or the processing module 1001 may comprise one or more of a receiving module 1010, a generating module 1020, a sending module 1030, a storing module 1040, a using module 1050, an establishing module 1060 as exemplifying hardware modules. In other examples, the aforementioned exemplifying hardware module may be implemented as one or more software modules. These modules are configured to perform a respective action as illustrated in e.g. FIG. 9.

Therefore, according to the various embodiments described above, the second node 140 is, e.g. by means of the processing module 1001 and/or any of the above mentioned modules, operative to, e.g. is configured to, perform the method of FIG. 9.

Hence, the second node 140 is configured for managing an update of a MAC address of a first node 130, wherein a Wireless Local Area Network “WLAN” connection is established between the first node 130 and the second node 140, wherein the first node 130 is identified by a first Media Access Control “MAC” address.

The second node 140, the processing module 1001 and/or the receiving module 1010 is configured for receiving, over the WLAN connection from the first node 130, a request for a second MAC address.

As mentioned, the request may include an indication that the second MAC address is requested. The request may include the second MAC address to be used by the first node 130 when connecting to the second node 140 at a later stage. The request may be included in a further Information element carried in an Action frame. The further Information element may be a further vendor specific element.

The second node 140, the processing module 1001 and/or the sending module 1030 may be configured for sending a response for indicating acknowledgement or non-acknowledgement of the request. The response may be included in an Information element carried in an Action frame. The Information element may be a vendor specific element.

The second node 140, the processing module 1001 and/or the storing module 1040 may be configured for storing 410 the second MAC address.

The second node 140, the processing module 1001 and/or the storing module 1040 may be configured for storing the second MAC address by further storing information relating to time of validity for the second MAC address.

As mentioned above, the first node 130 may be a wireless device 110 and wherein the second MAC address and the information relating to time of validity for the second MAC address may be included in a network profile.

The first node 130 may be a wireless access node 120 and wherein the second MAC address and the information relating to time of validity for the second MAC address may be included in a Station context.

The first node 130 may be a wireless device 110 and the second node 140 may be a wireless access node 120, or wherein the first node 130 may be a wireless access node 120 and the second node 130 may be a wireless device 110.

As used herein, the term “processing module” may in some examples refer to a processing circuit, a processing unit, a processor, an Application Specific integrated Circuit (ASIC), a Field-Programmable Gate Array (FPGA) or the like. As an example, a processor, an ASIC, an FPGA or the like may comprise one or more processor kernels. In these examples, the processing module is thus embodied by a hardware module. In other examples, the processing module may be embodied by a software module. Any such module, be it a hardware, software or combined hardware-software module, may be a determining means, estimating means, capturing means, associating means, comparing means, identification means, selecting means, receiving means, sending means or the like as disclosed herein. As an example, the expression “means” may be a module or a unit, such as a determining module and the like correspondingly to the above listed means. As used herein, the expression “configured to” may mean that a processing circuit is configured to, or adapted to, by means of software configuration and/or hardware configuration, perform one or more of the actions described herein.

As used herein, the term “memory” may refer to a hard disk, a magnetic storage medium, a portable computer diskette or disc, flash memory, Random Access Memory (RAM) or the like. Furthermore, the term “memory” may refer to an internal register memory of a processor or the like.

As used herein, the term “computer readable medium” may be a Universal Serial Bus (USB) memory, a DVD-disc, a Blu-ray disc, a software module that is received as a stream of data, a Flash memory, a hard drive, a memory card, such as a MemoryStick, a MultiMedia Card (MMC), etc.

As used herein, the term “computer readable code units” may be text of a computer program, parts of or an entire binary file representing a computer program in a compiled format or anything there between.

As used herein, the terms “number”, “value” may be any kind of digit, such as binary, real, imaginary or rational number or the like. Moreover, “number”, “value” may be one or more characters, such as a letter or a string of letters. “Number”, “value” may also be represented by a bit string.

As used herein, the expression “in some embodiments” has been used to indicate that the features of the embodiment described may be combined with any other embodiment disclosed herein.

Even though embodiments of the various aspects have been described, many different alterations, modifications and the like thereof will become apparent for those skilled in the art. The described embodiments are therefore not intended to limit the scope of the present disclosure.

1. A method, performed by a first node, for updating a MAC address of the first node, wherein a Wireless Local Area Network “WLAN” connection is established between the first node and a second node, wherein the first node is identified by a first Media Access Control “MAC” address, wherein the method comprises:
sending, over the WLAN connection to the second node, a request for a second MAC address.

2. The method according to claim 1, wherein the request includes an indication that the second MAC address is requested.

3. The method according to claim 1, wherein the request includes the second MAC address to be used by the first node when connecting to the second node at a later stage.

4. The method according to claim 1, wherein the method comprises:
receiving, from the second node, a response for indicating acknowledgement or non-acknowledgement of the request.

5. The method according to claim 4, wherein the response is included in an Information element carried in an Action frame.

6. The method according to claim 5, wherein the Information element is a vendor specific element.

7. The method according to claim 1, wherein the request is included in a further Information element carried in an Action frame.

8. The method according to claim 7, wherein the further Information element is a further vendor specific element.

9. The method according to claim 1, wherein the method comprises:
storing the second MAC address.

10. The method according to claim 9, wherein the storing comprises storing information relating to time of validity for the second MAC address.

11. The method according to claim 10, wherein the first node is a wireless device and wherein the second MAC address and the information relating to time of validity for the second MAC address is included in a network profile.

12. The method according to claim 10, wherein the first node is a wireless access node and wherein the second MAC address and the information relating to time of validity for the second MAC address is included in a Station context.

13. The method according to claim 1, wherein the first node is a wireless device and the second node is a wireless access, or wherein the first node is a wireless access node and the second node is a wireless device.

14. A method, performed by a second node), for managing an update of a MAC address of a first node, wherein a Wireless Local Area Network “WLAN” connection is established between the first node and the second node, wherein the first node is identified by a first Media Access Control “MAC” address, wherein the method comprises:
receiving, over the WLAN connection from the first node, a request for a second MAC address.

15. The method according to claim 14, wherein the request includes an indication that the second MAC address is requested.

16. The method according to claim 14, wherein the request includes the second MAC address to be used by the first node when connecting to the second node at a later stage.

17. The method according to claim 14, wherein the method comprises:
sending a response for indicating acknowledgement or non-acknowledgement of the request.

18. The method according to claim 17, wherein the response is included in an Information element carried in an Action frame.

19. The method according to claim 18, wherein the Information element is a vendor specific element.

20. The method according to claim 14, wherein the request is included in a further Information element carried in an Action frame.

21. The method according to claim 20, wherein the further Information element is a further vendor specific element.

22. The method according to claim 14, wherein the method comprises:
storing the second MAC address.

23. The method according to claim 22, wherein the storing comprises storing information relating to time of validity for the second MAC address.

24. The method according to claim 23, wherein the first node is a wireless device and wherein the second MAC address and the information relating to time of validity for the second MAC address is included in a network profile.

25. The method according to claim 23, wherein the first node is a wireless access node and wherein the second MAC address and the information relating to time of validity for the second MAC address is included in a Station context.

26. The method according to claim 14, wherein the first node is a wireless device and the second node is a wireless access node, or wherein the first node is a wireless access node and the second node is a wireless device.

27. A first node for updating a MAC address of the first node, wherein a Wireless Local Area Network “WLAN” connection is established between the first node and a second node, wherein the first node is identified by a first Media Access Control “MAC” address, wherein the first node is configured for sending, over the WLAN connection to the second node, a request for a second MAC address.

28. The first node according to claim 27, wherein the request includes an indication that the second MAC address is requested.

29. The first node according to claim 27, wherein the request includes the second MAC address to be used by the first node when connecting to the second node at a later stage.

30. The first node according to claim 27, wherein the first node is configured for receiving, from the second node, a response for indicating acknowledgement or non-acknowledgement of the request.

31. The first node according to claim 30, wherein the response is included in an Information element carried in an Action frame.

32. The first node according to claim 31, wherein the Information element is a vendor specific element.

33. The first node according to claim 27, wherein the request is included in a further Information element carried in an Action frame.

34. The first node according to claim 33, wherein the further Information element is a further vendor specific element.

35. The first node according to claim 27, wherein the first node is configured for storing the second MAC address.

36. The first node according to claim 35, wherein the first node is configured for storing the second MAC address by further storing information relating to time of validity for the second MAC address.

37. The first node according to claim 36, wherein the first node is a wireless device and wherein the second MAC address and the information relating to time of validity for the second MAC address is included in a network profile.

38. The first node according to claim 36, wherein the first node is a wireless access node and wherein the second MAC address and the information relating to time of validity for the second MAC address is included in a Station context.

39. The first node according to any one of claims 27, wherein the first node is a wireless device and the second node is a wireless access node, or wherein the first node is a wireless access node and the second node is a wireless device.

40. A second node for managing an update of a MAC address of a first node, wherein a Wireless Local Area Network “WLAN” connection is established between the first node and the second node, wherein the first node is identified by a first Media Access Control “MAC” address, wherein the second node is configured for receiving, over the WLAN connection from the first node, a request for a second MAC address.

41. The second node according to claim 40, wherein the request includes an indication that the second MAC address is requested.

42. The second node according to claim 40, wherein the request includes the second MAC address to be used by the first node when connecting to the second node at a later stage.

43. The second node according to claim 40, wherein the second node is configured for sending a response for indicating acknowledgement or non-acknowledgement of the request.

44. The second node according to claim 43, wherein the response is included in an Information element carried in an Action frame.

45. The second node according to claim 44, wherein the Information element is a vendor specific element.

46. The second node according to claim 40, wherein the request is included in a further Information element carried in an Action frame.

47. The second node according to claim 46 the preceding claim, wherein the further Information element is a further vendor specific element.

48. The second node according to claim 40, wherein the second node is configured for storing the second MAC address.

49. The second node according to claim 48, wherein the second node is configured for storing the second MAC address by further storing information relating to time of validity for the second MAC address.

50. The second node according to claim 49, wherein the first node is a wireless device and wherein the second MAC address and the information relating to time of validity for the second MAC address is included in a network profile.

51. The second node according to claim 49, wherein the first node is a wireless access node and wherein the second MAC address and the information relating to time of validity for the second MAC address is included in a Station context.

52. The second node according to claim 40, wherein the first node is a wireless device and the second node is a wireless access node, or wherein the first node is a wireless access node and the second node is a wireless device.

53-56. (canceled)
